(19) United States
(12) Patent Application Publication
(10) Pub. No.: US 2023/0067520 A1
(43) Pub. Date: Mar. 2, 2023

(54) HARD COATING FILM AND DISPLAY WINDOW INCLUDING THE SAME

(71) Applicant: DONGWOO FINE-CHEM CO., LTD., Jeollabuk-do (KR)

(72) Inventors: Jong Han CHOI, Gyeonggi-do (KR); Hyeong Wan NOH, Incheon (KR); Geo San LIM, Seoul (KR)

(21) Appl. No.: 17/884,651

(22) Filed: Aug. 10, 2022

(30) Foreign Application Priority Data
Aug. 10, 2021 (KR) 10-2021-0105505

(51) Int. Cl. C08J 7/04; C09D 143/04; C09D 133/14

(52) U.S. Cl. CPC C08J 7/042; C09D 143/04; C09D 133/14; C08J 2367/02; C08J 2443/04; C08J 2433/14

(57) ABSTRACT

A hard coating film according to an embodiment includes a substrate layer, a first hard coating layer formed on the substrate layer and satisfying a predetermined elastic recovery rate, and a second hard coating layer formed on the first hard coating layer and satisfying a predetermined water contact angle. The hard coating film according to embodiments may provide improved press resistance, scratch resistance, and flexibility.

### CROSS-REFERENCE TO RELATED APPLICATION AND CLAIM OF PRIORITY

This application claims the benefit under 35 USC § 119 of Korean Patent Application No. 10-2021-0105505 filed on Aug. 10, 2021 in the Korean Intellectual Property Office (KIPO), the entire disclosure of which is incorporated herein by reference for all purposes.

### BACKGROUND

### 1. Field of the Invention

The present invention relates to a hard coating film and a display window including the same, and more specifically, to a hard coating film having a multi-layered structure and a display window including the same.

### 2. Description of the Related Art

Recently, a thickness of an image display device such as a liquid crystal display (LCD) device or an organic light emitting display (OLED) device is consistently reduced. Thereby, the image display device is widely applied to various smart devices characterized by portability up to various wearable devices as well as smartphones and tablet PCs.

In order to protect the image display device from external environments such as a scratch, drop impact, external moisture, oil, and the like, a window film made of tempered glass may be formed on a display panel. However, the tempered glass is disadvantageous in terms of reducing a weight of the display panel or the image display device, and is easily broken by an external impact. In addition, there is a limitation in implementing flexible characteristics such as characteristics of being bendable or foldable.

Accordingly, in recent years, research on an optical plastic cover capable of replacing the window film made of tempered glass while securing flexibility and impact resistance has been conducted. The optical plastic cover may include, for example, polyethylene terephthalate (PET), polyethersulfone (PES), polyethylene naphthalate (PEN), polyacrylate (PAR), polycarbonate (PC), polyimide (PI) and the like.

However, the optical plastic cover may have lower hardness and scratch resistance than the window film made of tempered glass, and impact resistance to the external impact may be decreased.

Accordingly, development of a hard coating film with improved flexibility and impact resistance has been conducted. In addition, when applying the hard coating film as a display window, it is necessary to prevent a distortion in the optical characteristics due to the hard coating film so as not to cause a deterioration in quality of an image implemented through the image display device.

For example, Korean Patent Laid-Open Publication No. 2016-0100121 discloses a first hard coating composition including a (meth)acrylate monomer mixture, and a first hard coating film using the same, but it does not provide a hard coating film in which both the flexibility and optical characteristics are improved.

### SUMMARY

It is an object of the present invention to provide a hard coating film with improved flexibility and impact resistance.

In addition, another object of the present invention is to provide a display window including the hard coating film.

Further, another object of the present invention is to provide an image display device including the hard coating film.

To achieve the above objects, the following technical solutions are adopted in the present invention. 1. A hard coating film including: a substrate layer; a first hard coating layer formed on the substrate layer and having an elastic recovery rate (nIT) of 75% or more; and a second hard coating layer formed on the first hard coating layer and having a water contact angle of 100° or more. 2. The hard coating film according to the above 1, wherein the first hard coating layer includes a siloxane bond.

3. The hard coating film according to the above 2, wherein the first hard coating layer is formed from a first hard coating composition which includes a siloxane compound.

4. The hard coating film according to the above 3, wherein the siloxane compound includes a silsesquioxane compound containing a photo-curable functional group.

5. The hard coating film according to the above 1, wherein the second hard coating layer is formed from a second hard coating composition which includes a polymerizable compound containing a polyfunctional (meth)acrylate oligomer or (meth)acrylate monomer and a photo-initiator.

6. The hard coating film according to the above 5, wherein the second hard coating composition further includes a hydrophobic additive.

7. The hard coating film according to the above 6, wherein the hydrophobic additive contains a fluorine group and a photo-curable functional group. 8. The hard coating film according to the above 5, wherein the polymerizable compound includes a urethane (meth)acrylate compound.

9. The hard coating film according to the above 1, wherein the first hard coating layer has a thickness greater than or equal to that of the second hard coating layer.

10. A display window including the hard coating film according to the above 1.

11. An image display device including: a display panel; and the display window according to the above 10, which is disposed on the display panel.

According to exemplary embodiments, there is provided a hard coating film which includes a substrate layer, a first hard coating layer formed on the substrate layer and having an elastic recovery rate of 75% or more, and a second hard coating layer formed on the first hard coating layer and having a water contact angle of 100° or more. The hard coating film according to an exemplary embodiment may provide improved press resistance, scratch resistance, and flexibility, and may contribute to improvement of optical characteristics of a display window including the hard coating film.

The hard coating film according to exemplary embodiments includes a first hard coating layer with excellent recovery force to the press. Since the first hard coating layer is included in the hard coating film, it is possible to delay or prevent damage to the hard coating film due to the press, and consistently provide good feeling of writing.

In addition, the hard coating film according to exemplary embodiments includes a second hard coating layer capable of limiting attachment of oil. Since the second hard coating layer is included in the hard coating film, it is possible to suppress a distortion in the image due to fingerprints and the like. Further, since the second hard coating layer is formed on the first hard coating layer, the first hard coating layer is not directly exposed to moisture and air, and thereby life-span of the first hard coating layer may be extended.

Furthermore, the hard coating film is applied, for example, as a window film or a window substrate of the display device, such that it is possible to contribute to the improvement mechanical properties such as flexibility, press resistance, and scratch resistance of the display device and optical characteristics such as image sharpness.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross-sectional view illustrating a hard coating film according to exemplary embodiments; and

FIG. 2 is a schematic cross-sectional view for describing an image display device including a display window according to exemplary embodiments.

### DETAILED DESCRIPTION

A hard coating film according to exemplary embodiments includes a substrate layer, a first hard coating layer formed on the substrate layer, and a second hard coating layer formed on the first hard coating layer. In addition, the first hard coating layer satisfies a predetermined elastic recovery rate, and the second hard coating layer satisfies a predetermined water contact angle. Since the hard coating film includes the hard coating layer according to an exemplary embodiment, optical characteristics and mechanical properties of the hard coating film are improved. In addition, the present disclosure provides a display window which includes the hard coating film according to an exemplary embodiment.

Hereinafter, preferred embodiments of the present invention will be described in detail with reference to the accompanying drawings. However, since the drawings attached to the present disclosure are only given for illustrating one of several preferred embodiments of present invention to easily understand the technical spirit of the present invention with the above-described invention, it should not be construed as limited to such a description illustrated in the drawings.

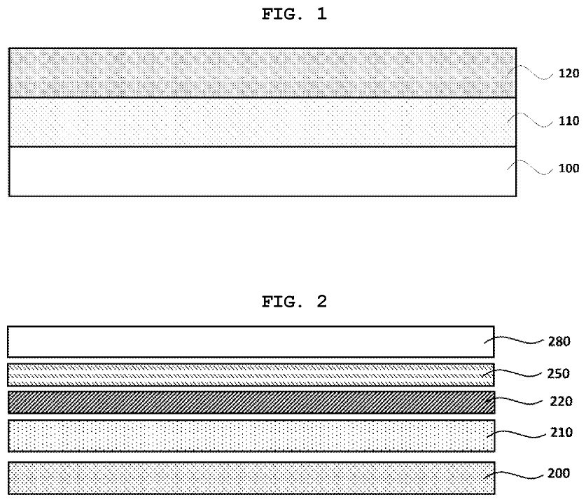

FIG. 1 is a schematic cross-sectional view illustrating a hard coating film according to exemplary embodiments. Referring to FIG. 1, the hard coating film includes a substrate layer 100, a first hard coating layer 110 formed on one surface of the substrate layer 100, and a second hard coating layer 120 formed on one surface of the first hard coating layer. The first hard coating layer satisfies a predetermined elastic recovery rate, and the second hard coating layer 120 satisfies a predetermined water contact angle.

The predetermined elastic recovery rate (nIT) may be 75% or more, and the predetermined water contact angle may be 100° or more. By satisfying the above-described numerical ranges, it is possible to simultaneously provide the first hard coating layer 110 with excellent recovery force and the second hard coating layer 120 capable of limiting attachment of oil. In addition, under the normal use conditions, physical deformation or chemical contamination of the hard coating film including the first hard coating layer 110 and the second hard coating layer 120 may be limited. Furthermore, an outer surface of a transparent display including the hard coating film may be constantly maintained, thus to delay and/or prevent a distortion in the image displayed thereon.

As the substrate layer 100, a transparent polymer film may be used so as to implement a transparent display. For example, the substrate layer 100 may include a polymer film such as triacetyl cellulose, acetyl cellulose butyrate, ethylene-vinyl acetate copolymer, propionyl cellulose, butyryl cellulose, acetylpropionyl cellulose, polyester, polystyrene, polyamide, polyetherimide, polyacryl, polyimide, polyethersulfone, polysulfone, polyethylene, polypropylene, polymethylpentene, polyvinyl chloride, polyvinylidene chloride, polyvinylalcohol, polyvinylacetal, polyetherketone, polyetheretherketone, polyethersulfone, polymethyl methacrylate, polyethylene terephthalate, polybutylene terephthalate, polyethylene naphthalate, polycarbonate and the like. The substrate layer 100 may include the above-described compounds alone or in combination with two or more thereof.

The first hard coating layer 110 may be formed by curing a first hard coating composition with ultraviolet rays or heat.

Prior to curing the first hard coating composition, the first hard coating composition may be uniformly applied to the substrate layer 100. The second hard coating layer 120 may be formed by curing a second hard coating composition with ultraviolet rays or heat. Prior to curing the second hard coating composition, the second hard coating composition may be uniformly applied to the first hard coating layer 110.

For example, the first hard coating composition and the second hard coating composition may be applied through printing or coating processes such as slit coating, knife coating, spin coating, casting, micro gravure coating, gravure coating, bar coating, roll coating, wire-bar coating, dip coating, spray coating, screen printing, gravure printing, flexo printing, offset printing, ink-jet coating, dispenser printing, nozzle coating, capillary coating methods and the like.

The first hard coating layer 110 may be formed on the substrate layer 100 and have an elastic recovery rate (nIT) of 75% or more. In one embodiment, the elastic recovery rate of the first hard coating layer 110 is preferably 80% or more, and more preferably 85% or more. The elastic recovery rate of the first hard coating layer 110 may be measured using a nanoindenter. When measuring the elastic recovery rate, a load applied to the first hard coating layer 110 may be 10 mN.

When satisfying the elastic recovery rate of the first hard coating layer 110 in the above-described numerical range, a press resistance of the hard coating film including the first hard coating layer 110 may be evaluated to be good or higher, or excellent or higher. In addition, in the normal use environments, a pressed portion may not be formed on a surface of the hard coating film including the first hard coating layer 110. As a result, for the display device including the hard coating film, visibility of the window may be improved, and the improved visibility may be constantly maintained.

The first hard coating layer 110 may be formed from a first hard coating composition including a siloxane compound. The siloxane compound refers to a silicon compound including a siloxane (Si—O—Si) bond. The first hard coating composition includes a siloxane compound, a photo-initiator, and a solvent, and may further include other additives.

In general, an Si—O bond is more thermally stable than a C—C bond, such that polymer compounds derived from the siloxane compound have superior impact resistance compared to carbon polymers. In addition, since the Si—O bond has a longer bond length than the C—C bond and the Si—O—Si bond has a greater bond angle than spa hybridized carbons, the polymer compounds derived from the siloxane compound have a better elastic recovery rate than the carbon resin.

The siloxane compound included in the first hard coating composition may include, for example, a T-type siloxane compound in which one alkyl group is bonded to a silicon (Si) element or a D-type siloxane compound in which two alkyl groups are bonded to the Si element.

The D-type siloxane compound may include, for example, polydialkylsiloxane such as polydimethylsiloxane (PDMS) and polymethylalkylsiloxane, polyether-modified polydimethylsiloxane, ethylene oxide substituent of dimethylpolysiloxane, acryl group substituent of dimethylpolysiloxane and the like.

The T-type siloxane compound may include, for example, a polysilsesquioxane compound. The polysilsesquioxane compound includes a silsesquioxane moiety. A silicon atom included in the silsesquioxane moiety is bonded to one alkyl group or alkoxy group. The polysilsesquioxane compound may be classified into a ladder type or a cage type polysilsesquioxane. A synthesis of the ladder type and the cage type polysilsesquioxanes may be performed by varying the alkyl group bonded to the silicon atom and reaction conditions.

The polysilsesquioxane compound may be obtained by thermal condensation of trialkoxysilane (R¹Si(OR²)₃), which is a type of silsesquioxane derivative, under water flow conditions or by thermal condensation of trichlorosilane (R³SiCl₃) under water flow conditions.

In an aspect that a dense network structure is formed by participating in a photo-curing reaction and the elastic recovery rate can be improved, preferably, the alkyl group included in the siloxane compound is a photo-curable functional group. Preferred photo-curable functional groups are, for example, ethylene oxide (epoxide) or acryl groups.

Further, in an aspect that a dense network structure is formed and thus the impact resistance and elastic recovery rate are more excellent, preferably, the siloxane compound included in the first hard coating composition includes a silsesquioxane compound containing the photo-curable functional group.

Commercially available products of the siloxane compound may include, for example, SY-ASO product manufactured by Sooyang Chemtec, MA0736 manufactured by Hybrideplastic, SF1000 mA manufactured by TWI, EFKA® 3030 manufactured by BASF, 2634 COATING manufactured by DOW CORNING, SH8400 manufactured by Toray and the like.

In exemplary embodiments, a content of the siloxane compound is preferably about 1 to 80 parts by weight, and more preferably 5 to 50 parts by weight based on 100 parts by weight of the first hard coating composition.

When the content of the siloxane compound is less than about 1 part by weight, pressure dispersion due to the siloxane compound may not be sufficiently performed at the time of pressing. For example, the press resistance of the hard coating film may be evaluated to be less than a predetermined value, and more specifically, may be evaluated to be below average. On the other hand, when the content of the siloxane compound exceeds about 80 parts by weight, a hardness is increased, such that applicability may be deteriorated and the elastic recovery rate may be insufficient.

The second hard coating composition includes a polymerizable compound, a hydrophobic additive, a photo-initiator, and a solvent, and may further include other additives.

The polymerizable compound may be a component which is cured by irradiating with light or by applying heat to provide a matrix of the first hard coating layer 120. According to exemplary embodiments, the polymerizable compound may include one or more of a polyfunctional (meth)acrylate oligomer and a (meth)acrylate monomer.

In the description of the present disclosure, (meth)acrylate is used to refer to both methacrylate and acrylate.

In addition, the polymerizable compound may contain a fluorine group. Due to containing of the fluorine group, hydrophobicity of the polymerizable compound may be increased. Further, the water contact angle of the second hard coating layer 120 including the polymerizable compound is preferably 100° to 135°, and more preferably 110° to 125°. When satisfying the water contact angle in the above-described numerical range, chemical contamination of the second hard coating layer 120 may be delayed, occurrences of stains and residues due to moisture, etc. may be limited, and an occurrence of haze on an image may be suppressed.

For example, when the water contact angle of the second hard coating layer 120 is less than 100°, oil and the like remain on the surface of the second hard coating layer 120, such that visibility may not be sufficiently secured. On the other hand, when the water contact angle of the second hard coating layer 120 exceeds 135°, light passing through the second hard coating layer 120 may be excessively scattered to generate haze on the image.

In some exemplary embodiments, the polyfunctional (meth)acrylate oligomer may be a (meth)acrylate oligomer including one or more of functional groups selected from the group consisting of an epoxy group, a urethane group, an amide group, and an ester group. In addition, from the viewpoint of excellent affinity with the hydrophobic additive to be described below, it is preferable that the polyfunctional (meth)acrylate oligomer is a urethane (meth)acrylate oligomer including at least one or more of urethane functional groups.

In addition, the urethane (meth)acrylate oligomer may be prepared by reacting (meth)acrylate containing a hydroxyl group with a compound containing an isocyanate group in the presence of a catalyst.

The (meth)acrylate containing a hydroxyl group may include, for example, 2-hydroxyethyl (meth)acrylate, 2-hydroxyisopropyl (meth)acrylate, 4-hydroxybutyl (meth)acrylate, caprolactone ring-opened hydroxyacrylate, a pentaerythritol tri/tetra(meth)acrylate mixture, a dipentaerythritol penta/hexa(meth)acrylate mixture, or a mixture thereof.

Further, the compound containing an isocyanate group may include, for example, 1,4-diisocyanatobutane, 1,6-diisocyanatohexane, 1,8-diisocyanantooctane, 1,12-diisocyanatododecane, 1,5-diisocyanato-2-methylpentane, trimethyl-1,6-diisocyanatohexane, 1,3-bis(isocyanantomethyl)cyclohexane, trans-1,4-cyclohexenediisocyanate, 4,4′-methylenebis(cyclohexylisocyanate), isophorone diisocyanate, toluene-2,4-diisocyanate, toluene-2,6-diisocyanate, xylene-1,4-diisocyanate, tetramethyl xylene-1,3-diisocyanate, 1-chloromethyl-2, 4-diisocyanate, 4,4′-methylenebis(2,6-dimethylphenylisocyanate), 4,4′-oxybis(phenylisocyanate), tri-functional isocyanate derived from hexamethylenediisocynate, trimethanepropanol adduct tolenediisocyanate, or a mixture thereof.

In addition, the urethane (meth)acrylate oligomer may include a compound respectively including two or more of a urethane functional group and a (meth)acryloyl group in a molecule. In addition, the urethane (meth)acrylate oligomer may be produced by reacting 1 mole of diisocyanate represented by Formula 1 below with 2 moles of an active hydrogen-containing polymerizable unsaturated compound. [Formula 1]

R₁—OC(═O) NH—R₃—NHC(═O) O—R₂

Wherein, R₁ and R₂ are each independently a substituent including a (meth)acryloyl group derived from an active hydrogen-containing polymerizable unsaturated compound, and R₃ is a divalent substituent derived from diisocyanate.

The urethane (meth)acrylate oligomer may include, for example, polymers obtained by reactions of 2-hydroxyethyl (meth)acrylate with 2,4-tolylene diisocyanate, 2-hydroxyethyl (meth)acrylate with isophorone diisocyanate, 2-hydroxybutyl (meth)acrylate with 2,4-tolylene diisocyanate, 2-hydroxybutyl (meth)acrylate with isophorone diisocyanate, pentaerythritol tri(meth)acrylate with 2,4-toluene diisocyanate, pentaerythritol tri(meth)acrylate with isophorone diisocyanate, pentaerythritol tri(meth)acrylate with dicyclohexyl methane diisocyanate, dipentaerythritol penta(meth)acrylate with isophorone diisocyanate, dipentaerythritol penta(meth)acrylate with dicyclohexylmethane diisocyanate.

In some exemplary embodiments, the (meth)acrylate monomer may include an unsaturated group such as a (meth)acryloyl group, a vinyl group, a styryl group, and an allyl group as a photo-curable group.

The (meth)acrylate monomer may include, for example, trimethylolpropane tri(meth)acrylate, pentaerythritol tri(meth)acrylate, glycerol tri(meth)acrylate, tris(2-hydroxyethyl)isocyanurate tri(meth)acrylate, ethyleneglycol di(meth)acrylate, propyleneglycol (meth)acrylate, 1,3-butanediol di(meth)acrylate, 1,4-butanediol di(meth)acrylate, 1,6-hexanediol di(meth)acrylate, neopentylglycol di(meth)acrylate, diethyleneglycol di(meth)acrylate, triethyleneglycol di(meth)acrylate, dipropyleneglycol di(meth)acrylate, bis(2-hydroxyethyl)isocyanurate di(meth)acrylate, or ethylene oxide derivatives thereof, propylene oxide derivatives; oligo ester (meth)acrylate having 1 to 3 (meth)acryloyl groups in a molecule, oligo ether (meth)acrylic acid ester, oligo urethane (meth)acrylic acid and oligo epoxy (meth)acrylic acid ester; hydroxyethyl (meth)acrylate, hydroxypropyl (meth)acrylate, hydroxybutyl (meth)acrylate; mono(meth)acrylic acid ester, for example, a monomer having (meth)acryloyl groups of tri-functional or less such as isooctyl(meth)acrylate, isodecyl(meth)acrylate, stearyl(meth)acrylate, tetrahydrofurfuryl(meth)acrylate, phenoxyethyl(meth)acrylate, etc.; and dipentaerythritol hexa(meth)acrylate, dipentaerythritol hydroxy penta(meth)acrylate, pentaerythritol tetra(meth)acrylate, ditrimethylolpropane tetra(meth)acrylate and the like. In addition, the above-described monomers may be used alone or in combination of two or more thereof.

In exemplary embodiments, the content of the polymerizable compound is preferably about 1 to 80 parts by weight, and more preferably 5 to 50 parts by weight based on 100 parts by weight of the second hard coating composition. When the content of the polymerizable compound is less than about 1 part by weight, an elastic modulus of the coating layer of the hard coating layer is decreased, such that cracks may easily occur in the coating layer during bending. On the other hand, when the content of the polymerizable compound exceeds about 80 parts by weight, viscosity is increased thereby causing a deterioration in applicability, and surface leveling is insufficient thereby causing a problem entailed in an appearance, as well as a curling phenomenon may occur in the second hard coating layer 120.

According to exemplary embodiments, a polymerization reaction of the (meth)acrylate group included in the polymerizable compound may be initiated by the photo-initiator, and a three-dimensional acrylic resin structure may be formed through a polymerization reaction of the (meth)acrylate group. In addition, the three-dimensional acrylic resin structure may include, for example, a network structure.

The photo-initiator may include, for example, a Type I photo-initiator which generates a radical by degradation of a molecule, and a Type II photo-initiator which coexists with a tertiary amine to induce recapture of hydrogen. In addition, the content of the photo-initiators may be controlled by those skilled in the art to properly induce curing of each hard coating composition.

The Type I photo-initiator may include, for example, acetophenones such as 4-phenoxy dichloro acetophenone, 4-t-butyl dichloro acetophenone, 4-t-butyl trichloro acetophenone, diethoxy acetophenone, 2-hydroxy-2-methyl-1-phenylpropan-1-one, 1-(4-isopropylphenyl)-2-hydroxy-2-methylpropane-1-one, 1-(4-dodecylphenyl)-2-hydroxy-2-methylpropane-1-one, 4-(2-hydroxyethoxy)-phenyl (2-hydroxy-2-propyl)ketone, 1-hydroxycyclohexyl phenylketone, etc.; benzoins such as benzoin, benzoin methylether, benzoin ethylether, benzyl dimethylketal, etc.; phosphine oxides; titanocene compounds and the like.

The Type II photo-initiator may include, for example, benzophenones such as benzophenone, benzoylbenzoic acid, benzoylbenzoic acid methylether, 4-phenylbenzophenone, hydroxybenzophenone, 4-benzoyl-4′-methyldiphenyl sulfide, 3,3′-methyl-4-methoxybenzophenone, etc., or thioxanthones, 2-chlorothioxanthone, 2-methylthioxanthone, 2,4-dimethylthioxanthone, isopropylthioxanthone and the like.

As the above-described photo-initiator, one type may be used or two or more types may be mixed and used. The Type 1 and Type II photo-initiators may be used alone or together with each other.

In exemplary embodiments, the photo-initiator may be included in an amount of about 0.1 to 10 parts by weight, and preferably about 0.1 to 5 parts by weight based on each of total 100 parts by weight of the first and second hard coating compositions. When the content of the photo-initiator is less than about 0.1 parts by weight, curing is insufficient, such that mechanical properties and adhesion of the hard coating film or the hard coating layer may not be secured. When the content of the photo-initiator exceeds about 10 parts by weight, a curing reaction rate is excessively fast, such that shrinkage in the (meth)acrylate group may occur, and bonding failure, cracks, and curling of the hard coating layer may be caused.

In some exemplary embodiments, the polymerizable compound may further include a hydrophobic additive. Further, in an exemplary embodiment, the hydrophobic additive may include a polysiloxane compound or an aliphatic compound having 4 to 20 carbon atoms.

In some exemplary embodiments, the hydrophobic additive included in the second hard coating layer may exhibit a concentration gradient. In addition, the concentration gradient of the hydrophobic additive may be formed so that the concentration of the hydrophobic additive is increased as it gets closer to the surface of the second hard coating layer from an interface with the first hard coating layer.

In some exemplary embodiments, the silicon atom included in the polysiloxane compound is preferably bonded to a straight or branched chain alkyl group having 4 to 20 carbon atoms. By satisfying the number of alkyl groups bonded to the silicon atom in the above-described range, lipophilicity of the hydrophobic additive is further increased, and the water contact angle of the hard coating film may be implemented to be 90° or more even without including the hydrophobic additive in an excessive amount.

Further, in some exemplary embodiments, the hydrophobic additive may include an aliphatic compound having 4 to 20 carbon atoms. By using the aliphatic compound satisfying the above-described range of the carbon atoms, a water contact angle of a predetermined range or more may be implemented.

For example, when using an aliphatic compound having less than 4 carbon atoms, a length of the chain included in the hydrophobic additive is too short, such that the lipophilicity of the hard coating layer including the same may be insufficient.

On the other hand, when using an aliphatic compound having more than 20 carbon atoms, the hydrophobic compound may be excessively aggregated due to insufficient affinity with the polymerizable compound including a plurality of hydrophilic functional groups, and the mechanical properties and optical characteristics of the hard coating layer may be deteriorated.

Further, in some exemplary embodiments, the hydrophobic additive may include one or more fluorine groups. Since the hydrophobic additive containing the fluorine groups is included in the second hard coating composition, it is possible to implement a water contact angle of the second hard coating layer in a predetermined range or more by adding a slight amount of the hydrophobic additive. For example, through the use of the aliphatic compound containing fluorine groups, the water contact angle of the second hard coating layer may be implemented to be 100° or more.

Additionally, in some exemplary embodiments, the hydrophobic additive may include one or more photo-curable functional groups. The photo-curable functional group may include, for example, carbon-carbon multiple bonds such as a carbon vinyl group, an allyl group, or an alkyne group. Since the hydrophobic additive includes one or more photo-curable functional groups, the hydrophobic additive can be participated in a polymerization reaction of the polymerizable compound. As a result, the hydrophobic additive may be chemically bonded to a matrix structure formed by the polymerization reaction.

In the first and second hard coating compositions according to embodiments of the present invention, solvents commonly used in the art may be used without limitation thereof.

For example, as a solvent, an alcohol solvent (methanol, ethanol, isopropanol, butanol, propyleneglycol methoxyalcohol, etc.), ketone solvent (methylethylketone, methylbutylketone, methylisobutylketone, diethylketone, dipropylketone, etc.), acetate solvent (methyl acetate, ethyl acetate, butyl acetate, propyleneglycol methoxy acetate, etc.), cellosolve solvent (methyl cellosolve, ethyl cellosolve, propyl cellosolve, etc.), hydrocarbon solvent (normal hexane, normal heptane, benzene, toluene, xylene, etc.), and the like may be used. These solvents may be used alone or in combination of two or more thereof.

The content of the solvent is not particularly limited as long as it is an amount capable of dissolving the components contained in the above-described composition, and may be included in a balance of the overall composition except for the above-described components and/or additives to be described below. For example, the solvent may be included in an amount of about 20 to 70 parts by weight based on each of total 100 parts by weight of the first and second hard coating compositions.

When the content of the solvent is less than about 20 parts by weight, viscosities of the first and second hard coating compositions may be excessively increased, thereby reducing applicability and workability. When the content of the solvent exceeds about 70 parts by weight, it is difficult to uniformly form a thickness of the hard coating layer, and stains or residues may be formed on the surface of the hard coating layer during drying, and thereby causing damage to the optical characteristics of the hard coating film.

The first and second hard coating compositions may further include other additives to improve physical properties such as film uniformity within a range that does not deteriorate the mechanical properties and transparency of the hard coating film, the first hard coating layer 110, or the second hard coating layer 120. For example, the other additives may include a leveling agent, a UV stabilizer, a thermal stabilizer and the like.

For example, the leveling agent may be added to the first or second hard coating composition to improve smoothness and coating properties of the first hard coating layer 110 or the second hard coating layer 120. The leveling agent may include, for example, silicone, fluorine, or acrylic polymer.

Commercially available leveling agents may include, for example, BYK-307, BYK-323, BYK-331, BYK-333, BYK-337, BYK-373, BYK-375, BYK-377, BYK-378, and BYK-UV3570 manufactured by BYK Chemicals;

TEGO Glide 410, TEGO Glide 411, TEGO Glide 415, TEGO Glide 420, TEGO Glide 432, TEGO Glide 435, TEGO Glide 440, TEGO Glide 450, TEGO Glide 455, TEGO Rad 2100, TEGO Rad 2200N, TEGO Rad 2250, TEGO Rad 2300, TEGO Rad 2500 TEGO Rad 2200N, TEGO Rad TEGO Rad 2300 and TEGO Rad 2500 manufactured by TEGO Co.; and FC-4430 and FC-4432 manufactured by 3M and the like.

In some embodiments, the first and second hard coating compositions may further include a UV stabilizer and/or a thermal stabilizer. The UV stabilizer blocks or absorbs UV rays, thereby preventing the surface of the first hard coating layer 110 or the second hard coating layer 120 formed from the first and second hard coating compositions from discoloring or crumbling due to an exposure to UV rays. The UV stabilizers may be classified into absorbents, quenchers, and hindered amine light stabilizers (HALSs) according to an action mechanism thereof. The UV stabilizer may include, for example, phenyl salicylates (absorbents), benzophenone (absorbents), benzotriazole (absorbents), nickel derivatives (quenchers), radical scavengers and the like. In addition, as non-limited examples, the thermal stabilizer may include polyphenol, phosphite, and lactone thermal stabilizers.

Other additives may be appropriately mixed and used at a level that does not deteriorate the UV curing process and the hardness and optical characteristics of the hard coating layer. For example, the other additives may be included in an amount of about 0.1 to 1 part by weight based on each of total 100 parts by weight of the first and second hard coating compositions.

Fingerprint visibility of the first hard coating layer 110 which may be exposed adjacent to a visible side of a user is improved, such that transparency and image characteristics through an image display device or a display window may be further enhanced.

In addition, mechanical strength and scratch resistance of the hard coating film may be improved through the formation of the first hard coating layer 110. Accordingly, it is possible to secure flexibility and bending properties through the substrate layer 100, and secure mechanical strength and hardness in a predetermined range or more through the first hard coating layer 110 which may be exposed to the window surface. Thereby, a display window with improved flexibility and mechanical durability may be implemented from the above-described hard coating film.

According to exemplary embodiments, the first hard coating layer 110 may have a thickness of about 1 to 30 μm. When the thickness of the first hard coating layer 110 is too thick, the flexibility and bending properties through the substrate layer 100 are deteriorated, such that the thickness thereof is preferably about 30 μm or less. On the other hand, when the thickness of the first hard coating layer 110 is too thin, the elastic recovery of the hard coating film is insufficient, and the press resistance of the hard coating film is insufficient, as well as a pressure mark may be permanently formed on the surface of the hard coating film, such that the thickness thereof is preferably about 1 μm or more.

According to exemplary embodiments, the second hard coating layer 120 may have a thickness of about 1 to 30 μm. When the thickness of the second hard coating layer 120 is too thick, the flexibility and bending properties through the substrate layer 100 are deteriorated, such that the thickness thereof is preferably about 30 μm or less. On the other hand, when the thickness of the second hard coating layer 120 is too thin, peel-off and rupture of the second hard coating layer 120 due to folding or the like may occur, such that the thickness thereof is preferably about 1 μm or more.

In addition, it is more preferably that the first hard coating layer 110 has a thickness equal to that of the second hard coating layer 120 or thicker than that of the second hard coating layer. When the thickness of the first hard coating layer 110 is thicker than that of the second hard coating layer 120, the press resistance of the hard coating film may be further improved.

In some exemplary embodiments, it is more preferably that the thickness of the first hard coating layer 110 is one to five times thicker than that of the second hard coating layer 120. When the thickness of the first hard coating layer 110 satisfies the above-described numerical range, the press resistance may be evaluated to be excellent.

For example, when the thickness of the first hard coating layer 110 is thinner than that of the second hard coating layer 120, the press resistance and elastic recovery rate may be insufficient. In addition, a pressed portion which is not recovered even under a load of about 1 Kg may be formed on the surface of the hard coating film. On the other hand, when the thickness of the first hard coating layer 110 is more than five times thicker than that of the second hard coating layer 120, the flexibility and bending properties of the hard coating film may be deteriorated.

The thickness of the substrate layer 100 is not particularly limited, but may be about 10 to 100 μm, and may be about 20 μm to 80 μm in consideration of the bending properties.

In some embodiments, the second hard coating layer 120 may further include a protective film (not illustrated) (e.g., a release film) formed thereon. For example, the protective film may be attached on the second hard coating layer 120 through an adhesive layer.

According to exemplary embodiments of the present invention, a display window or a window laminate including the above-described hard coating film may be provided. In addition, an image display device including the above-described hard coating film may be provided.

FIG. 2 is a schematic cross-sectional view for describing an image display device including a display window according to exemplary embodiments. The image display device may include a display window 280.

The display window 280 includes, for example, a hard coating film, and in one embodiment, a light-shielding pattern (not illustrated) may be formed on a periphery of one surface of the display window 280. The light-shielding pattern may include, for example, a color printing pattern, and may have a single-layered or multi-layered structure. A bezel part or a non-display region of the image display apparatus may be defined by the light-shielding pattern.

An optical layer 250 may include various optical films or optical structures included in the image display device, and in some embodiments, may include a coating-type polarizer or a polarizing plate. In addition, the optical layer may continuously extend over the non-display region or the bezel part.

The coating-type polarizer may include a liquid crystal coating layer containing a polymerizable liquid crystal compound and a dichroic dye. In this case, the optical layer 250 may further include an alignment film for endowing alignment properties to the liquid crystal coating layer.

For example, the polarizing plate may include a polyvinyl alcohol polarizer and a protective film attached to at least one surface of the polyvinyl alcohol polarizer.

The optical layer 250 may be directly adhered to the one surface of the display window 280 or may be attached through a second adhesive layer (not illustrated). In an embodiment, the optical layer 250 may be coupled to a touch sensor layer 220 through a first adhesive layer (not illustrated).

As shown in FIG. 2, the display window 280, the optical layer 250, and the touch sensor layer 220 may be disposed in this order from the visible side of the user. In this case, since sensing electrodes of the touch sensor layer 220 are disposed under the optical layer 250 including the polarizer or the polarizing plate, it is possible to more effectively prevent a phenomenon in which the electrode is viewed.

In addition, a coupling layer 210 may be formed on an upper surface of a display panel 200. For example, when the display panel 200 includes an encapsulation layer on an upper portion thereof, the coupling layer 210 may be formed on the encapsulation layer of the display panel 200.

In exemplary embodiments, the coupling layer 210 may include a pressure-sensitive adhesive (PSA) or an optically clear adhesive (OCA), which include an acrylic resin.

A touch sensor layer 220 may be laminated on the coupling layer 210. The touch sensor layer 220 may be coupled to the display panel 200 through the coupling layer 210. Accordingly, the display panel 200 and the touch sensor layer 220 may be integrally formed into one module.

Further, in some exemplary embodiments, the optical layer, the touch sensor layer, and/or the coupling layer may be provided as one unit. In this case, the use of the adhesive layer is decreased, thereby enabling the thickness of the image display device to be additionally reduced.

The display panel 200 may include a pixel electrode, a pixel defining layer, a display layer, a counter electrode, and an encapsulation layer, which are disposed on a panel substrate.

The panel substrate may include a flexible resin material, and in this case, the image display device may be provided as a flexible display.

A pixel circuit including a thin film transistor (TFT) may be formed on the panel substrate, and an insulation film may be formed to cover the pixel circuit. The pixel electrode may be electrically connected to a drain electrode of the TFT on the insulation film, for example.

The pixel defining film may be formed on the insulation film to expose the pixel electrode, thus to define a pixel region. The display layer is formed on the pixel electrode, and the display layer may include, for example, a liquid crystal layer or an organic light emitting layer.

The counter electrode may be disposed on the pixel defining film and the display layer. The counter electrode may be provided, for example, as a common electrode or a cathode of the image display device. The encapsulation layer for protecting the display panel may be laminated on the counter electrode.

The display window may include, for example, a display panel and a touch sensor layer which are integrally formed with each other. The optical layer may be laminated on a display region D of the touch sensor layer. In FIG. 2, for the convenience of description, a support structure and a flexible circuit board will not be illustrated.

The hard coating film or display window included in the image display device according to an exemplary embodiment has excellent hardness, abrasion resistance, and flexibility. In addition, the hard coating film or the display window may be applied as a window film formed on the outermost surface of the image display device. The hard coating film or the display window may suppress oil attached to the surface from being viewed and consistently provide excellent light transmittance.

The image display device includes various image display devices such as a liquid crystal display device, an electro luminescent display device, a plasma display device, and an electro emission display device, and may be a flexible image display device having flexibility and bending characteristics. In this case, a base substrate of the display panel may also be, for example, a flexible resin substrate such as polyimide.

Hereinafter, specific experimental examples are proposed to facilitate understanding of the present invention. However, the following examples are only given for illustrating the present invention and those skilled in the art will obviously understand that various alterations and modifications are possible within the scope and spirit of the present invention. Such alterations and modifications are duly included in the appended claims.

### PREPARATIVE EXAMPLE

Preparative Example 1

30 parts by weight of silsesquioxane acrylate (SY-ASO 101, Sooyang Chemtec), 1 part by weight of a photo-initiator (Irgacure-184, Ciba), 0.3 parts by weight of a leveling agent (BYK-307), 68.7 parts by weight of methyl ethyl ketone were stirred and mixed using a stirrer. Then, the mixture was filtered through a polypropylene (PP) filter to prepare a first hard coating composition.

Preparative Example 2

A first hard coating composition was prepared according to the same procedures as described in Preparative Example 1, except that silsesquioxane acrylate (SY-ASO 102L, Sooyang Chemtec) was used instead of the silsesquioxane acrylate (SY-ASO 101, Sooyang Chemtec).

Preparative Example 3

A first hard coating composition was prepared according to the same procedures as described in Preparative Example 1, except that silsesquioxane acrylate (MA0736, Hybrideplastic) was used instead of the silsesquioxane acrylate (SY-ASO 101, Sooyang Chemtec).

Preparative Example 4

A first hard coating composition was prepared according to the same procedures as described in Preparative Example 1, except that silsesquioxane acrylate (SF1000MA, TWI) was used instead of the silsesquioxane acrylate (SY-ASO 101, Sooyang Chemtec).

Preparative Example 5

A first hard coating composition was prepared according to the same procedures as described in Preparative Example 1, except that an acrylate monomer (MIRAMER M340, Miwon Co.) containing three functional groups was used instead of the silsesquioxane acrylate (SY-ASO 101, Sooyang Chemtec).

Preparative Example 6

22.65 parts by weight of a urethane acrylate oligomer containing six functional groups (UA-110H, Shin-Nakamura), 22.65 parts by weight of an acrylate monomer containing three functional groups (MIRAMER M340, Miwon Co.), 3.5 parts by weight of a photo-initiator (Irgacure-184, Ciba), 1 part by weight of a hydrophobic additive (KY-1203, Shinetsu Co.) containing a fluorine group and a photo-curable functional group, and 50.2 parts by weight of methyl ethyl ketone were stirred and mixed using a stirrer. Then, the mixture was filtered through a PP filter to prepare a second hard coating composition. An elastic recovery rate measured in the same manner as Preparative Example 1 to be described below was 67%.

Examples and Comparative Examples

Examples and comparative examples were prepared using the first hard coating composition and the second hard coating composition prepared in the above respective preparative examples. The preparative example numbers used in each example and comparative example are shown in Table 1 below. In all examples and comparative examples, the second hard coating layer was formed to be disposed on one surface of the first hard coating layer.

In each example and comparative example, polyethylene terephthalate (PET) was used as a substrate, and the thicknesses of the substrates were the same as each other to be 50 μm. The first hard coating composition was coated on the prepared substrate using a bar coater, and a solvent was removed at 90° C. for 2 minutes. Thereafter, the first hard coating composition was cured by irradiating the first hard coating composition from which the solvent was removed with UV rays in a light amount of 100 mJ/cm² to form a first hard coating layer.

In addition, the second hard coating composition was coated on the first hard coating layer using a bar coater, followed by removing the solvent at 90° C. for 2 minutes. Thereafter, the second hard coating composition was cured by irradiating the second hard coating composition from which the solvent was removed under a nitrogen condition with UV rays in a light amount of 500 mJ/cm² to form a second hard coating layer.

The preparative example numbers and the thicknesses of the hard coating layers used in each example and comparative example are shown in Table 1 below.

TABLE 1

| | | First hard coat layer | | Second hard coat layer | |
|---|---|---|---|---|---|
| | | Preparative | Thick- | Preparative | Thick- |
| | | example | ness | example | ness |
| Example | 1 | 1 | 5 μm | 6 | 5 μm |
| | 2 | 2 | | 6 | |
| | 3 | 3 | | 6 | |
| | 4 | 1 | | 6 | |
| | 5 | 2 | 10 μm | 6 | |
| | 6 | 3 | | 6 | |
| | 7 | 4 | | 6 | |
| Comparative | 1 | — | | 6 | 5 μm |
| example | 2 | 5 | 5 μm | 6 | |
| | 3 | 1 | | 5 | |
| | 4 | — | | 5 | |
| | 5 | 6 | 5 μm | 1 | — (Non- |
| | | | | | uniform) |

In the case of Examples 1 to 7, the first hard coating layer and the second hard coating layer could be uniformly formed. The hard coating films of Comparative Examples 1 and 4 included only the second hard coating layer.

In addition, in the case of the hard coating film of Comparative Example 5, the second hard coating layer was not uniformly formed on the first hard coating layer due to a de-wetting phenomenon, and was excluded from the following experiment subject.

Experimental Example

Physical properties of the hard coating films of the examples and comparative examples were evaluated as follows.

1) Evaluation of water contact angle

After dropping 2 ml of deionized water on the surface of the hard coating film at room temperature (25° C.), 1 minute later, a contact angle to the deionized water was measured using a contact angle measuring instrument (DSA100, KRUSS). Left and right contact angles of water droplets on the same sample were measured 5 times, and an average value thereof was calculated to evaluate as the water contact angle.

2) Evaluation of press resistance

After each hard coating film was fixed with a tape on glass, the press resistance of the hard coating film was evaluated using a Texture Analyzer (TA.XT.Plus C) of Stable Micro Systems. A circular probe having a diameter of 5 mm was used for evaluation of the press resistance.

The surface of the hard coating film was pressed with a circular probe for 10 seconds in a pressure from 1 kg to 5 kg at an interval of 0.5 kg. Thereafter, the hard coating film was left for 24 hours under conditions at a temperature of 25° C. and a relative humidity of 50%, and whether the pressed portion is viewed or not was visually confirmed. Specific standards for evaluation of the press resistance are as follows.

<Standards for Evaluation>
⊚ (Excellent): The portion pressed with 4 kg to 5 kg was viewed
∘ (Good): The portion pressed with 3 kg to 4 kg was viewed
Δ (Average): The portion pressed with 2 kg to 3 kg was viewed
× (Below average): The portion pressed with 2 kg or less was viewed

3) Evaluation of scratch resistance

The second hard coating layer was fixed to be positioned on the surface, and the scratch resistance was tested by reciprocating 500 times under a load of 500 g/cm² using a steel wool tester (WT-LCM100, Korea Protec). Steel wool of #0000 was used, and the standards for evaluation of the scratch resistance are as follows.

<Standards for evaluation>
∘ (Good): Less than 5 scratches occurred
× (Below average): 5 or more scratches occurred
4) Evaluation of bending property

The hard coating film was folded so as to bring both ends of an outer surface of the second hard coating layer included in the hard coating film into contact with each other. When both ends of the second hard coating layer come into contact with each other, a diameter thereof was 2 mm. Folding was performed by repeating a total of 200,000 times. The standards for evaluation of bending properties are as follows.

<Standards for evaluation>

∘ (Good): No crack and breakage occurred

× (Below average): Cracks or breakages occurred
5) Evaluation of adhesion

The hard coating film was attached to the glass so that the second hard coating layer included in the hard coating film was disposed on the top, and the adhesion of the first hard coating layer and the second hard coating layer was evaluated based on ASTM D3359. The standards for evaluation of the adhesion are as follows.

<Standards for Evaluation>
5B: No peel-off observed
4B: Less than 5% peel-off observed
3B: 5 to 15% peel-off observed
2B: 15 to 35% peel-off observed
1B: 35 to 65% peel-off observed
OB: 65% or more peel-off observed
6) Measurement of elastic recovery rate (nIT)

The elastic recovery rate of the first hard coating layer included in the hard coating film of each example and comparative example was measured using a nanoindenter (manufactured by Fisher Instruments Co., Ltd., picodenter HM-500, indenter: Vickers type).

In order to measure the elastic recovery rate of the first hard coating layer included in the hard coating film of each example and comparative example, the hard coating film was cut in a vertical direction, and pressed with a load of 10 mN so that the pressing direction is perpendicular to the cut surface of the first hard coating layer. The elastic recovery rate of the first hard coating layer to the above press was measured to be 87%.

7) Measurement of compressive elastic modulus

The compressive elastic modulus of the hard coating film of each example and comparative example was measured using a Picodenter HM-500 manufactured by Fisher Instruments Co., Ltd. For the measurement of the compressive elastic modulus, the Vickers type indenter was used. The measurement was performed according to ISO-FDIS 14577-1:2015, and a load of 5 mN was applied to each hard coating film.

Evaluation results for each example and comparative example are shown in Table 2 below. The elastic recovery rate and the compressive elastic modulus in Table 2 below refer to the elastic recovery rate and the compressive elastic modulus of the first hard coating layer.

TABLE 2

| | | Evaluation item | | | | | | |
|---|---|---|---|---|---|---|---|---|
| | | Water | | | | | Elastic | Compressive |
| Evaluation | | contact | Press | Scratch | Bending | | recovery | elastic |
| subject | | angle | resistance | resistance | property | Adhesion | rate | modulus |
| Example | 1 | 113° | ◯ | ◯ | ◯ | 5B | 87% | 2542 |
| | 2 | 111° | ◯ | ◯ | ◯ | 5B | 89% | 1325 |
| | 3 | 112° | ◯ | ◯ | ◯ | 5B | 85% | 2584 |
| | 4 | 113° | ⊚ | ◯ | ◯ | 5B | 87% | 2542 |
| | 5 | 111° | ⊚ | ◯ | ◯ | 5B | 89% | 1325 |
| | 6 | 112° | ⊚ | ◯ | ◯ | 5B | 85% | 2584 |
| | 7 | 112° | ◯ | ◯ | ◯ | 5B | 82% | 3864 |
| Comparative | 1 | 113° | X | ◯ | ◯ | 5B | — | — |
| example | 2 | 112° | X | ◯ | ◯ | 5B | 69% | 3972 |
| | 3 | 97° | ◯ | X | ◯ | 5B | 87% | 2542 |
| | 4 | 97° | X | X | ◯ | 5B | — | — |

Referring to Table 2, the examples and comparative examples were evaluated to have excellent bending properties and adhesion of 5B. However, in the case of Comparative Examples 3 and 4 in which the products of Preparative Example 5 were used as the second hard coating layer, it was evaluated that scratch resistance was to be below average.

In addition, in the case of Examples 1 to 3 and Comparative Example 3 in which the products of Preparative Examples 1 to 3 were used as the first hard coating layer, it was evaluated that the press resistance was excellent or higher. In the case of Examples 4 to 6 in which the thickness of the first hard coating layer was thicker than that of the second hard coating layer, it was evaluated that the press resistance was improved compared to Examples 1 to 3 in which the thickness of the first hard coating layer was the same as that of the second hard coating layer. The hard coating film of Examples 4 to 6 had to be pressed with a load of 4.5 Kg or more such that the pressed portion could be visually observed.

In the case of Comparative Examples 1 and 4 which do not include the first hard coating layer, it was evaluated that the press resistance was to be below average. In the case of Comparative Example 1 and Comparative Example 4, a portion pressed with a load of 1.0 Kg or more was visually observed. In the case of Comparative Example 2, it was evaluated that the press resistance was to be below average, and a portion pressed with a load of 1.5 Kg or more was visually observed.

In addition, in Comparative Example 5, a fingerprint might be easily viewed by forming the second hard coating layer using the first hard coating composition, and it might be expected that the scratch resistance of the second hard coating layer is insufficient.

According to Table 2, in the exemplary examples and comparative examples, it was found that the elastic recovery rate and the compressive elastic modulus of the first hard coating layer did not have a positive correlation. For example, the elastic recovery rate of Example 1 was evaluated to be 5% higher than that of Example 7, but it was found that the compressive elastic modulus of Example 1 was a level of about 65% of the compressive elastic modulus of Example 7.

What is claimed is:

1. A hard coating film comprising:
a substrate layer;
a first hard coating layer formed on the substrate layer and having an elastic recovery rate (nIT) of 75% or more; and
a second hard coating layer formed on the first hard coating layer and having a water contact angle of 100° or more.

2. The hard coating film according to claim 1, wherein the first hard coating layer comprises a siloxane bond.

3. The hard coating film according to claim 2, wherein the first hard coating layer is formed from a first hard coating composition which comprises a siloxane compound.

4. The hard coating film according to claim 3, wherein the siloxane compound comprises a silsesquioxane compound containing a photo-curable functional group.

5. The hard coating film according to claim 1, wherein the second hard coating layer is formed from a second hard coating composition which comprises a polymerizable compound containing a polyfunctional (meth)acrylate oligomer or (meth)acrylate monomer and a photo-initiator.

6. The hard coating film according to claim 5, wherein the second hard coating composition further comprises a hydrophobic additive.

7. The hard coating film according to claim 6, wherein the hydrophobic additive contains a fluorine group and a photo-curable functional group.

8. The hard coating film according to claim 5, wherein the polymerizable compound comprises a urethane (meth)acrylate compound.

9. The hard coating film according to claim 1, wherein the first hard coating layer has a thickness greater than or equal to that of the second hard coating layer.

10. A display window comprising the hard coating film according to claim 1.

11. An image display device comprising:
a display panel; and
the display window according to claim 10, which is disposed on the display panel.
